(19) United States
(12) Patent Application Publication
(10) Pub. No.: US 2006/0168343 A1
(43) Pub. Date: Jul. 27, 2006

(54) Method and system for radio link establishment and maintenance with p2p communication in wireless communication

(75) Inventors: Ni Ma, Shanghai (CN); Li Sun, Shanghai (CN); Qunli Jia, Shanghai (CN); Xuejun Zhang, Shanghai (CN); Jiang cheng, Shanghai (CN); Yueheng Li, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/547,587

(22) PCT Filed: Mar. 1, 2004
(86) PCT No.: PCT/IB04/50182

§ 371 Date: Sep. 1, 2005

(30) Foreign Application Priority Data
Mar. 7, 2003 (CN) 03119895.3

(51) Int. Cl. G06F 15/173; G06F 15/16

(52) U.S. Cl. 709/245; 709/224

(57) ABSTRACT

A method is provided for establishing P2P radio connection in wireless communication networks, comprising: the user equipment, as the link probing originator, transmits link probing signals via the allocated direct communication link to another user equipment as the link probing responder, according to the initial probing power provided by the wireless communication system; said another user equipment transmits the ACK message to the link probing originator via the direct communication link when receiving the link probing signals and said link probing signals meet the basic requirement for direct communication; the user equipment, as the link probing originator, monitors the direct communication link, and communicates directly with the link probing responder via the direct communication link after detecting the ACK message from the link probing responder. This method effectively guarantees the procedure of establishing P2P communication between the user equipments in P2P communication course, by utilizing the link probing process of transmitting link probing signals.

### FIELD OF THE INVENTION

The present invention relates generally to a P2P communication in wireless communication networks, and more particularly, to a method and system for radio link establishment and maintenance with P2P communication in wireless communication networks.

### BACKGROUND OF THE INVENTION

In conventional cellular mobile communication systems, regardless of the distance between two communicating UEs (user equipments), a UE has to communicate with another UE only through the relaying of a base station. FIG. 1 illustrates the conventional communication mode, where UE1 and UE2 interact with each other through the UTRAN consisting of the base station transceiver (namely Node B) and the RNC, and this communication mode is also called UP-UTRAN-DOWN mode. However, in the case that two UEs camping in the same cell are very close to each other, it can be more reasonable for them to communicate directly, rather than being relayed/forwarded by base stations. This method is the so-called peer-to-peer communication, abbr. as P2P.

FIG. 2 shows a P2P communication mode, wherein the dashed line represents signaling link, the solid line represents data link, and the arrowhead represents the direction of information flow. Only signaling link exists between the UTRAN (or namely base station subsystem) and the UEs, while only data link exists between two communicating UEs. Assume that only resource for maintaining basic communication is needed, and a direct link is taken as one unit of radio resource (with fixed frequency, timeslot and spreading code), it can be easily inferred that the P2P communication mode only needs two units of radio resource to maintain basic communication. If additional signaling cost is ignored, P2P communication can save about 50% radio resource than conventional communication mode. Meanwhile, the UTRAN still holds control over P2P communication, especially over how to use radio resources, so network operators can easily solve the billing issue for P2P communication.

A method and system for establishing P2P communication in wireless communication networks is described in a patent application document, entitled “A Method and System for Establishing P2P Communication in Wireless Communication Networks”, submitted along with the present application document, assigned to the assignee of the present invention, Royal Philips Electronics whose archive ID is CN030003, and incorporated herein by reference.

According to the method and system for P2P communication in wireless communication networks described in the application document, the calling UE requesting for P2P communication first sends a P2P call request to the UTRAN via uplink control channel; the UTRAN sends a paging message to the called UE according to the call request of the calling UE; the called UE sends a call response to the UTRAN according to the paging message from the UTRAN; the UTRAN judges whether the two UEs are in the same cell according to the registry information and position information of the calling and called UEs, and computes whether the distance between them satisfies the requirement for P2P communication; when the distance between the calling and called UEs satisfies the requirement for P2P communication and the two UEs both have P2P communication capability, the UTRAN allocates direct communication link for the two UEs to allow them to perform P2P communication; after acquiring the channel resource allocated by the UTRAN, the two UEs respectively send ACK messages of P2P establishment to the UTRAN and enter into P2P direct communication mode.

After entering into P2P direct communication mode, the two UEs can exchange information through the allocated P2P-DCH (P2P Dedicated Channel).

However, the receiver sensitivity and antenna height of the UE may be greatly different from those of Node B in the UTRAN, hence, the P2P communication establishment procedure between the two UEs could be of some difference from the communication establishment procedure between the UE and Node B.

Furthermore, the radio channel condition between two UEs is different from that between the UE and Node B in the UTRAN during P2P communication process, thus the P2P communication maintenance procedure between two UEs could be of some difference from the communication maintenance procedure between the UE and Node B.

Additionally, a UE in P2P communication may be unable to continue P2P communication because of some environmental factors. Thus, how to switch smoothly from P2P communication mode to conventional communication mode without visible notice of communicating subscribers, arises as an important issue to be considered when employing P2P communication mode.

### SUMMARY OF THE INVENTION

An object of the present invention is to provide a method and system for radio link establishment with P2P communication in wireless communication networks, to adapt to the change during communication establishment procedure caused by difference between receiver sensitivity and antenna height of the UE and those of Node B, and the particularity of P2P communication link, such as communication range, signal strength and etc.

Another object of the invention is to provide a method and system for radio link maintenance with P2P communication in wireless communication networks, to adapt to the change during communication maintenance procedure caused by the difference between the channel condition between the UEs and that between the UE and Node B.

Another object of the invention is to provide a method and system for switching from P2P mode to conventional mode in wireless communication networks, so as to switch to conventional communication mode smoothly without visible notice of the communicating subscribers when P2P communication can no longer be conducted.

In accordance with one aspect of the present invention, there is provided a method for P2P radio link establishment in wireless communication networks, wherein, after acquiring the allocated direct communication link, the UE, as the link probing originator, will take steps as follows:

transmitting connect probing signals with preset initial probing power over the allocated direct communication link, to another UE who acts as the link probing responder;

monitoring the direct communication link, to detect an ACK (Acknowledgement) message from the link probing responder;

communicating directly via the direct communication link with the link probing responder, after receiving the ACK message from the link probing responder;

In accordance with one aspect of the present invention, there is provided a method for P2P radio link establishment in wireless communication networks, wherein, after acquiring the allocated direct communication link, the UE, as the link probing responder, will take steps as follows:

receiving the connect probing signals from said another UE who acts as the link probing originator via direct communication link;

sending an ACK message to the link probing originator via the direct communication link, after receiving the connect probing signal and the connect probing signal meets the basic requirement for direct communication.

In accordance with one aspect of the present invention, there is provided a method for P2P radio link establishment in wireless communication networks, wherein, after acquiring the allocated direct communication link, the UEs, as the link probing originator or link probing responder, will take different steps respectively.

When the UE acts as the link probing originator, steps to be taken includes:

transmitting connect probing signals with preset initial probing power via the allocated direct communication link, to another UE who acts as the link probing responder;

monitoring the direct communication link, to detect an ACK message from said another UE who acts as the link probing responder;

communicating directly via the direct communication link with said another UE who acts as the link probing responder, after receiving the ACK message from the link probing responder.

When the UE acts as the link probing responder, steps to be taken includes:

receiving the connect probing signal from said another UE who acts as the link probing originator via direct communication link;

sending an ACK message to said another UE who acts as the link probing originator via the direct communication link, after receiving the connect probing signal and the connect probing signal meets the basic requirement for direct communication.

A method is proposed in this invention for P2P radio link establishment to be used in the base station subsystem in wireless communication networks, comprising:

receiving request signals from the link probing originator and response signals from the link probing responder;

transmitting the message for setting the initial probing power to the link probing originator via the downlink control channel according to the request signal and the response signal, after allocating direct communication link to the UEs.

A method is proposed in this invention for P2P radio link maintenance in wireless communication networks, wherein, after the base station subsystem already allocates direct communication link for the UE, steps to be taken by the UE includes:

transmitting signals to another UE via the direct communication link;

receiving the signals transmitted from said another UE via the direct communication link;

detecting whether the signals from said another UE meet the basic Qos requirement for direction communication;

determining the power control indication according to a certain criterion if the basic Qos requirement for direction communication is met;

inserting the power control indication into signals to be transmitted to said another UE;

adjusting the transmission power of the UE according to the power control indication in the signals sent via the direct communication link from said another UE.

A method is proposed in this invention for the UEs to switch from P2P communication mode to conventional communication mode in wireless communication networks, comprising:

the UE in direct communication mode sends a request to the base station subsystem via uplink control channel, for switching to conventional communication mode;

entering into the dual-mode state of direct communication and conventional communication, after receiving the ACK message of the request for switching sent by the base station subsystem via the downlink control channel and acquiring the reallocated traffic channel in conventional communication mode;

sending a request to the base station subsystem for releasing the direct communication radio resource after entering into the dual-mode state;

switching to mere conventional communication mode from the dual-mode state of direct communication and conventional communication after receiving the ACK message of the request for releasing the direct communication radio resource sent by the base station subsystem via the downlink control channel.

A method is proposed in this invention for switching from P2P communication to conventional communication to be used in base station subsystem in wireless communication networks, comprising:

receiving requests for switching to conventional communication mode sent from the UEs in direct communication mode via the uplink control channel;

sending ACK messages of the requests for switching via the downlink control channel, to the two UEs in direct communication mode and reallocating traffic channels in conventional communication mode for them to enter into the dual-mode state of direct communication and conventional communication;

receiving requests for releasing direct communication radio resource sent from the two UEs;

reclaiming the direct communication radio resource;

sending ACK messages of the requests for releasing direct communication radio resource via the downlink control channel to the two UEs, after reclaiming the direct communication radio resource.

### BRIEF DESCRIPTION OF THE DRAWINGS

FIG. 1 is a schematic diagram for illustrating the conventional cellular communication mode;

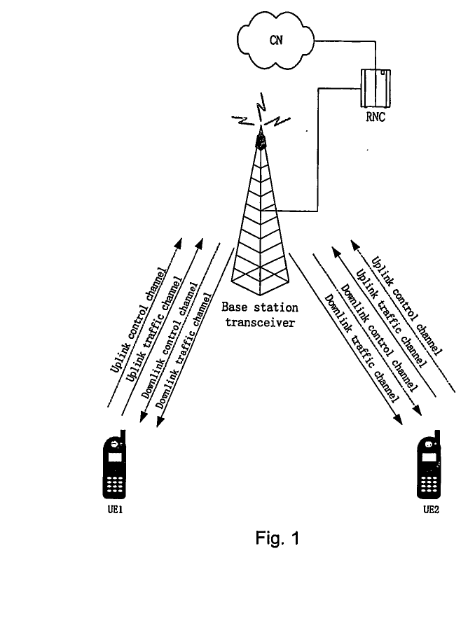

FIG. 2 is a schematic diagram for illustrating the P2P communication mode;

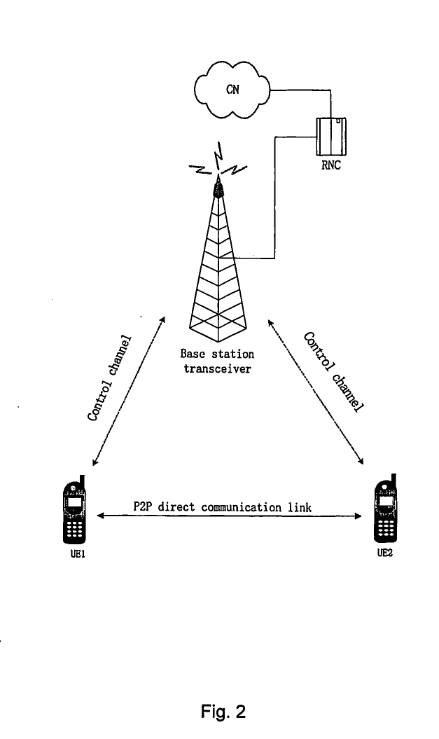

FIG. 3 is a schematic diagram for illustrating the general P2P communication procedure;

FIG. 4 is a schematic diagram for illustrating P2P radio link establishment and maintenance procedure;

FIG. 5 is a schematic diagram for illustrating P2P connect probing procedure;

FIG. 6 is a schematic diagram for illustrating P2P link maintenance procedure of UE1;

FIG. 7 is a schematic diagram for illustrating P2P link maintenance procedure of UE2.

### DETAILED DESCRIPTION OF THE PREFERRED EMBODIMENTS

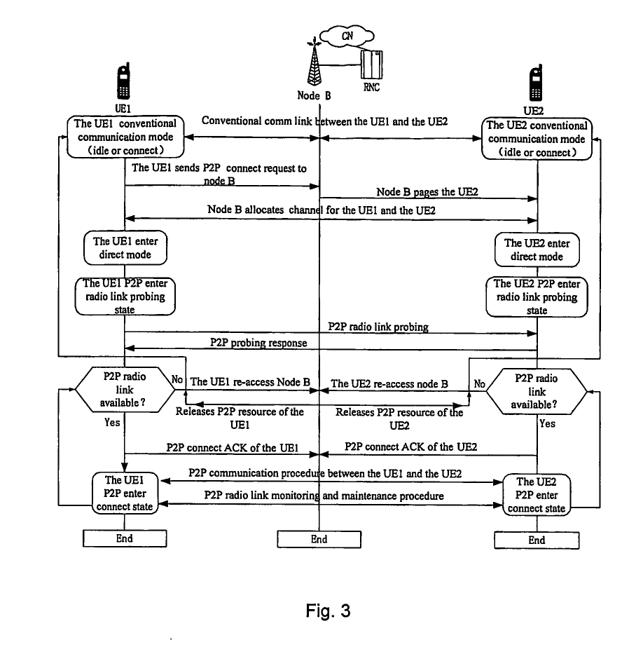

To get a more clarified understanding about the procedures of P2P communication link establishment, maintenance and smooth switching to conventional communication mode as proposed in the present invention, a brief description will first be given to the general procedure of P2P communication request, establishment, maintenance and switching to conventional mode involved in P2P communication, in conjunction with FIG. 3. Then, detailed descriptions will be offered respectively to link establishment, maintenance and switching to conventional mode involved in the present invention.

Referring to FIG. 3, a general P2P communication procedure comprises:

1. The UE Enters into Direct Mode

This procedure comprises the following steps:

(1) Same as conventional communication mode, the UE1 and UE2 enter into IDLE mode after powering on.

(2) When trying to launch P2P communication with the UE2, the UE1 sends a P2P connect request to the UTRAN via uplink control channel.

(3) On receipt of the P2P connect request, the UTRAN sends a paging message to the UE2 through the paging channel, notifying that the UE1 wants to launch P2P communication with it.

(4) Suppose that the UE1 and UE2 are in the same cell, and the distance between them meets the requirement for P2P communication and the UE1 and UE2 both have P2P communication capability, after receiving the response of the said paging message from UE2, the UTRAN allocates channel resource related with P2P communication (i.e. P2P-DCH) to the UE1 and UE2.

Here, the physical channel structure of P2P-DCH, such as frame, burst structure, spreading code, scrambling code, midamble and etc, is all the same as the conventional one; while the messages, contents and parameters carried on the channel should be modified adaptively according to P2P communication mode. Appendix 1 lists the main parameters and some original values to be modified in existing technical specifications for P2P TDD CDMA (only as reference here).

(5) After acquiring the allocated channel resource, the UE1 and UE2 respectively send ACK messages about that relevant P2P resource has been acquired and the P2P resource has already been activated to the UTRAN; meanwhile, the UE1 and UE2 send their capability messages needed during P2P dialogue, such as receiver sensitivity, power level and etc, to another corresponding UE in the P2P communication via Node B in the UTRAN.

(6) The UE1 and UE2 enter into direct communication mode. The UE that has entered into direct communication mode is denoted as P2P-UE in this article.

2. Connect Probing Procedure

After entering into direct communication mode, the UE1 and UE2 enter into radio link probing state, in which the UE1 and UE2 perform connect probing procedure via P2P-DCH, so as to determine parameters such as the transmission power of the UE1 and UE2 in P2P communication.

(1) If connect probing succeeds, i.e. P2P radio link is available, the UE1 and UE2 respectively send ACK messages to Node B in the UTRAN via the control channel between UE1 and Node B and that between UE2 and Node B. Meanwhile, the UE1 and UE2 start to communicate through P2P-DCH, that is, the UE1 and UE2 enter into P2P connect state.

In P2P connect state, there only exists dedicated traffic channel between the UE1 and the UE2, and control channels respectively exist between the UE1 and Node B and between the UE2 and Node B. In this state, Node B in the UTRAN can still manage to overhear information exchanged between the UE1 and the UE2 on P2P-DCH.

(2) If connect probing fails, i.e. P2P radio link is not available, the UE1 and UE2 return to conventional communication mode.

3. Link Monitor and Maintenance Procedure

After connect probing succeeds, the UE1 and UE2 enter into P2P communication mode. But the UE1 and UE2 still need to constantly monitor the P2P link performance during P2P communication process, so as to maintain the P2P radio link.

4. “Soft” Switching to Conventional Communication Mode

When the P2P link turns out to be unavailable, Node B in the UTRAN or the UEs themself will break down the P2P connection, then, the UE1 and UE2 will return to conventional communication mode.

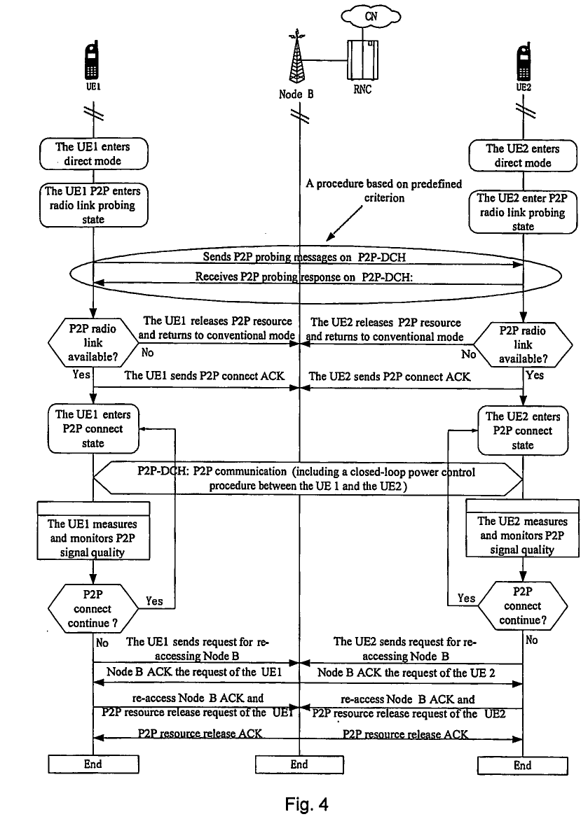

A brief description is given in conjunction with FIG. 3 above, to P2P communication request, establishment, maintenance and switching to conventional communication mode from P2P mode involved in a general P2P communication procedure. Compared with FIG. 3, the procedures before the UE1 and UE2 enter into direct communication mode are ignored in FIG. 4, while procedures of P2P connection establishment, maintenance and smooth switching to conventional mode involved in the present invention are given particular attention. Further descriptions will be offered in the following to the communication procedures involved in the present invention, in conjunction with FIG. 4.

1. About the Procedure of Connect Probing

(1) After entering into direct communication mode, the UE who is designated by the UTRAN as the link probing originator (or the caller), sends connect probing signals to another UE who acts as the link probing responder, with preset initial probing power and via the acquired direct communication link P2P-DCH.

Wherein:

(I) The initial probing power can be determined according to the estimated path-loss between the link probing originator and the link probing responder within the acceptable radio range of P2P communication, the receiver sensitivity and the transmission power level of the link probing responder, and etc.

(II) All these needed parameters can be obtained from the message sent by Node B when responding the UE's P2P request.

(III) Utilizing P2P-DCH to send connect probing signals, it not only saves radio resource and ensures the reliability of connect probing procedure, but also reduces the complexity of P2P signaling procedure.

(2) The another UE who acts as the link probing responder, waits for the connect probing signal from the link probing originator on this P2P-DCH channel, and prepares to send ACK message to the link probing originator via the P2P-DCH channel after receiving the connect probing signal.

(3) Step (1) and step (2) can be iterated based on the predefined parameters, that is:

A step size can be set for connect probing power change. If the ACK message from the link probing responder is not received within a certain time period, the connect probing power can be adjusted according to this step size, and connect probing signals can be retransmitted with the adjusted power.

A counter can also be set for recording the number of re-transmitting connect probing signals, or a maximum value can be set for the connect probing power. When the number of re-transmitting connect probing signals exceeds the set maximum value of the counter or the adjusted connect probing power exceeds the set maximum value of the connect probing power, connect probing signals will no longer be sent.

A timer can also be set for the link probing responder. If connect probing signals from the link probing originator are not yet received when exceeding the period predefined by the timer, the UE will no longer wait but enter into conventional communication mode.

The above connect probing procedure can be performed bi-directionally (FDD systems need to be like this). In TDD systems, thanks to the link's mutual coupling, only single-directional probing is needed.

2. Link Monitor and Maintenance Procedure

During dialogue between the UE1 and the UE2, that is, when in P2P connect state, the UE1 and UE2 continuously detect their received signal quality. Similar to standard power control scheme between the UE and Node B, a closed-loop power control method will be executed between the UE1 and the UE2, so as to maintain normal P2P communication, till the UEs break down the P2P communication themself or the UTRAN terminates the P2P connection.

Wherein, when the UE1 and the UE2 are detecting their received signals, self-defined criterions, e.g. whether the SIR of the received signals is less than a predefined threshold or whether signals from another P2P-UE are not yet received within a certain time period, can be adopted to determine whether the P2P connection can go on.

3. “Softly” Switching to Conventional Communication Mode

During P2P communication, when a decision is made to switch from P2P connection to conventional communication mode because the P2P-UE's communication performance can't satisfy the QoS requirement, steps to be executed include:

(1) First, the UE sends an access request to Node B in the UTRAN via uplink control channel, which is a standard random access procedure same as conventional mode.

(2) On receipt of the access request from the UE, Node B reallocates traffic channel for the two UEs when sending ACK messages of the access request to the UEs respectively.

Wherein, Node B only allocates downlink traffic channel for the UEs, while uplink traffic channel can still be P2P-DCH, because Node B can still overhear the information exchanged between the UEs on P2P-DCH even during P2P communication. Thus, P2P-DCH can also be taken as the uplink traffic channel in conventional UP-UTRAN-DOWN mode.

(3) On receipt of the ACK messages of the access request from Node B via downlink control channel and acquiring the reallocated traffic channels, the two UEs both enter into the dual-mode state of direct communication and conventional communication.

(4) After entering into the dual-mode state, the two UEs respectively send ACK messages of switching to conventional mode to the UTRAN and send request for releasing direct communication radio resource.

(5) On receipt of the ACK messages of switching to conventional mode and the requests for releasing the direct communication radio resource sent by the two UEs, Node B in the UTRAN starts to reclaim the direct communication radio resource. After the direct communication radio resource is released, Node B sends the ACK message of releasing the direct communication radio resource to the two UEs via the downlink control channel.

Before the direct communication radio resource is released entirely, the UEs can't enter into mere conventional UP-UTRAN-DOWN mode completely. In other words, only after the two UEs can communicate through Node B, the P2P link will be broken down so as to ensure “softly” or “transparently” switching to conventional communication mode.

(6) On receipt of the ACK messages of releasing the direct communication radio resource sent by the UTRAN via the downlink control channel, the two UEs switch from the dual-mode sate of direct communication and conventional communication, to mere conventional communication mode.

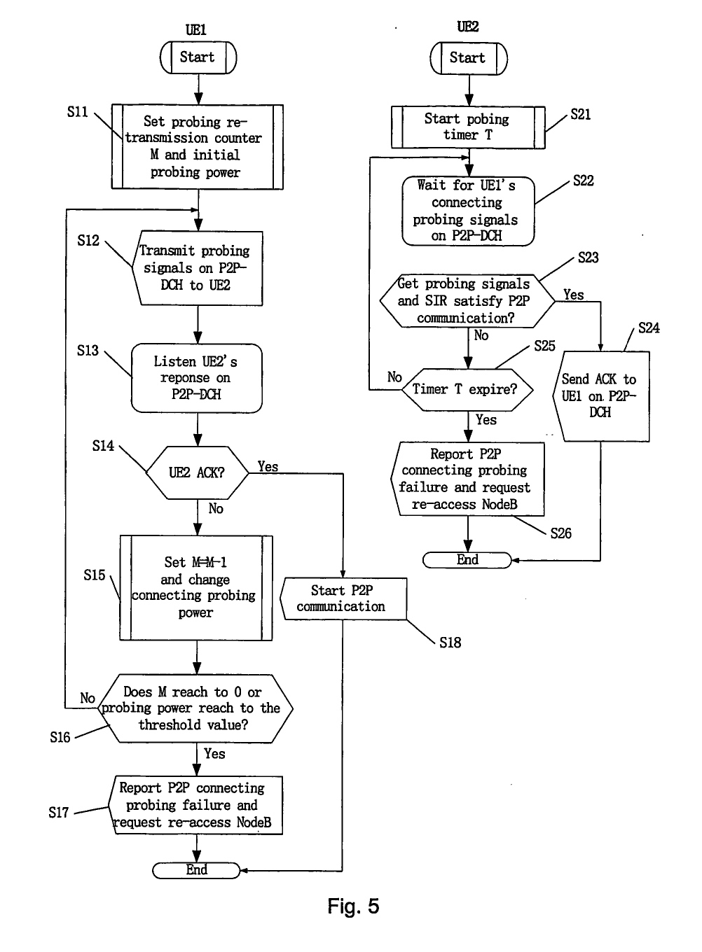

During P2P communication, procedures of link establishment, maintenance and smooth switching to conventional communication mode are the essential part of the invention. After further descriptions are given to the three procedures in conjunction with FIG. 4, detailed descriptions will be given below to the specific steps of link probing, monitor and detection in procedures of link establishment and maintenance, in conjunction with FIGS. 5, 6 and 7.

As shown in FIG. 5, assume that the UE1 is the link probing originator and the UE2 is the link probing responder, steps to be executed include:

Steps to be taken by the UE1 are as follows:

1. Sets probing re-transmission counter M, the initial probing power, step size of the probing power change and the allowable maximum probing power (step S11);

2. Sends P2P connect probing signals to the UE2 via P2P-DCH with the initial probing power (step S12);

3. Monitors response from the UE2 on P2P-DCH (step S13);

4. Judges whether the UE2 returns response (step S14); if the UE2 does, starts P2P communication with the UE2 on P2P-DCH (step S18);

5. If the UE2 doesn't respond, changes the probing power according to the step size, decreases probing signal retransmission counter M by 1 and then retransmits the connect probing signals (step S15);

6. Judges whether the probing retransmission counter is 0 or the probing power reaches the allowable maximum probing power (step S16); if the probing retransmission counter M is 0 or the probing power reaches the allowable maximum probing power, meanwhile the UE1 can't receive response from the UE2 yet, sends request for re-accessing the UTRAN due to connect probing failure to the UTRAN (step S17).

Steps to be taken by the UE2 are as follows:

1. Sets the minimum SIR satisfying the communication requirement, sets and enables probing timer T (step S21);

2. Waits on P2P-DCH for the connect probing signals from the UE1 (step S22);

3. Judges whether the connect probing signals are received and whether the SIR of the signals satisfies the basic requirement for P2P communication (step S23); if the connect probing signals are received and the SIR of the signals satisfies the basic requirement for P2P communication, sends P2P connect probing response to the UE1 via P2P-DCH (step S24);

4. Otherwise, checks whether timer T expires (step S25). If yes, sends request for re-accessing the UTRAN due to connect probing failure (step S26); if no, returns to step S22 to wait for the connect probing signals.

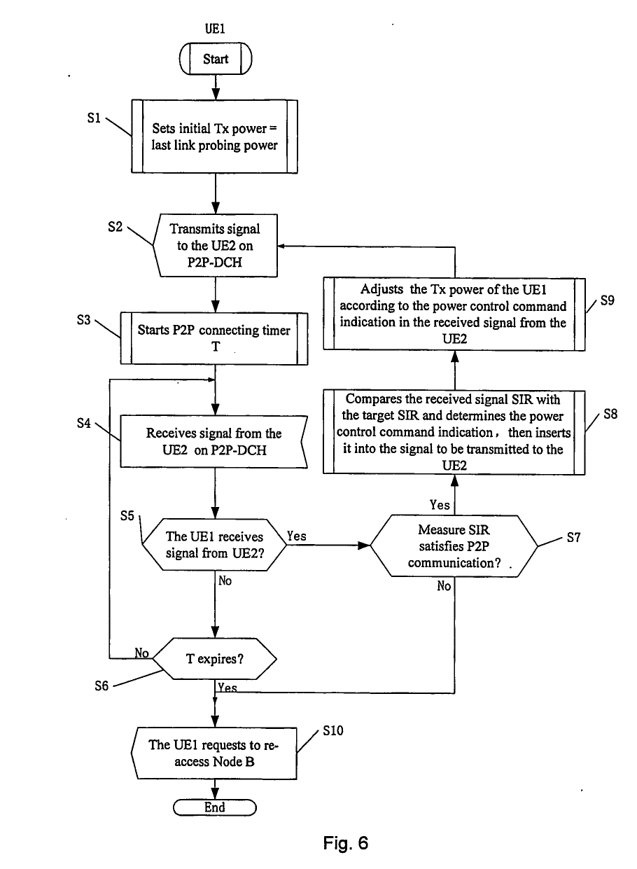

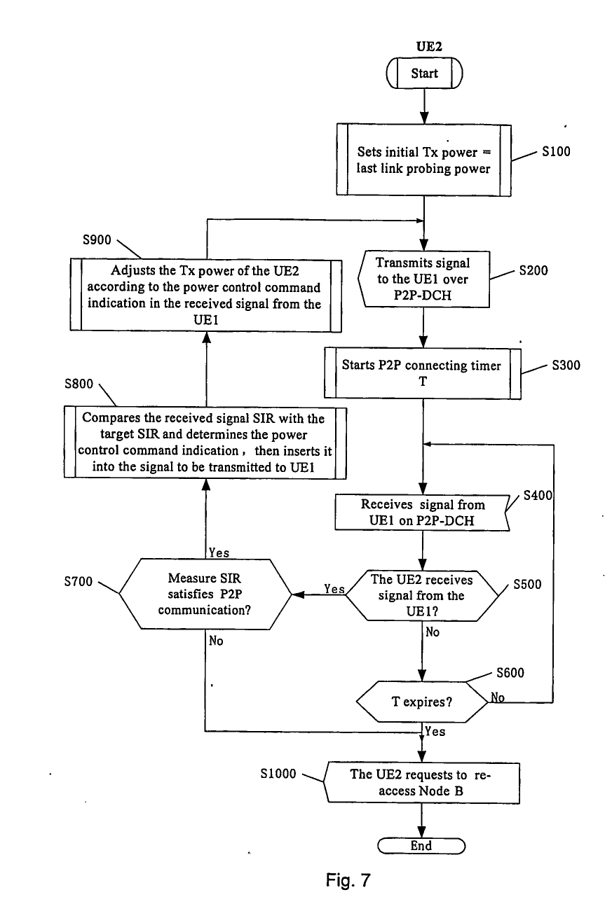

FIGS. 6 and 7 respectively describe the steps in which the UE1 and UE2 adjust their transmission power according to the received signals during P2P communication, wherein it's supposed that the UE1 is the caller or the P2P communication originator designated by the UTRAN while the UE2 is the callee.

Show as FIG. 6, steps to be taken by the UE1 include:

First, sets the initial transmission power as the power value determined in the last connect probing procedure (step S1); sends signals to the UE2 via direct communication link P2P-DCH (step S2); then enables P2P connecting timer T (step S3), and stars to receive signals from the UE2 via P2P-DCH (step S4); judges whether signals from the UE2 are received (step S5); if signals from UE2 via P2P-DCH are not received, judges whether timer T expires (step S6); if timer T expires, requests to re-access Node B (step S10); if signals from the UE2 via P2P-DCH are received, detects whether the signals from the UE2 satisfy the basic QoS requirement for direct communication (e.g. SIR), (step S7); if the basic QoS requirement for direct communication is not satisfied, requests to re-access Node B (step S10); when the basic QoS requirement for direct communication is satisfied, compares the SIR of the received signals with the target SIR to determine the power control indication, and inserts the power control indication into the signals to be transmitted to the UE2 (step S8); adjusts the transmission power according to the power control indication in the signals from the UE2 via the direct communication link (step S9).

Show as FIG. 7, steps to be taken by the UE2 include:

First, sets the transmission power as the power value determined during the last connect probing procedure (step S100); afterwards, sends signals to the UE1 via direct communication link P2P-DCH (step S200); then, starts P2P connecting timer T (step S300), and starts to receive signals from the UE1 via P2P-DCH (step S400); judges whether signals from the UE1 are received (step S500); if signals from UE2 via P2P-DCH are not received, judges whether timer T expires (step S600); if timer T expires, requests to re-access Node B (step S1000); on receipt of signals from the UE1 via P2P-DCH, detects whether the signals from the UE1 satisfy the basic QoS requirement for direct communication (e.g. SIR) (step S700); if the basic QoS requirement for direct communication is not satisfied, requests to re-access Node B (step S1000); if the basic QoS requirement for direct communication is satisfied, compares the SIR of the received signals with the target SIR to determine the power control indication, and inserts the power control indication into the signals to be transmitted to the UE1 (step S800); adjusts the transmission power according to the power control indication in the signals from the UE1 via the direct communication link (step S900).

In the P2P communication monitor procedure as illustrated in FIGS. 6 and 7, the target SIR used for determining power control commands can be acquired from the UTRAN via the downlink control channel at the beginning of the P2P communication, or adjusted directly by the UEs themself according to the QoS requirement or measurement statistics. Furthermore, the UTRAN can also adjust the target SIR according to the overheard information over P2P-DCH.

Moreover, detailed description is given in 3GPP TS 25.221, “Physical channels and mapping of transport channels onto physical channels (TDD)” to the location of the power control indication, (e.g., TPC—transmission power control symbol) in traffic burst structure.

Full descriptions are offered above to the involved procedures of connect probing, P2P communication maintenance and smooth switching from P2P communication to conventional mode, in conjunction with accompanying figures. All the related parameters during each foregoing procedure can be implemented by modifying high-layer software in existing communication systems, therefore the hardware modules in existing communication systems can be greatly reused. In other words, link probing, maintenance and switching procedures can be achieved by only modifying existing high-layer protocol software so that the UTRAN can transfer the messages needed for link probing, maintenance and switching to conventional communication mode to the UEs via control channels and modifying the corresponding software to be executed on the UEs meanwhile, without altering the hardware settings of the existing UEs and base station subsystem.

This invention can be implemented both in hardware and software, as well as in combination of hardware and software. When it's to be implemented in hardware, the relevant components are as follows:

1. Connect Probing Procedure

1. About the UEs

(1). When the UE allocated with direct communication link acts as the link probing originator, the system for P2P radio link establishment of the UE in wireless communication systems, includes: connect probing signal transmitting unit, for transmitting connect probing signals with preset initial probing power to another UE who acts as the link probing responder via the allocated direct communication link, wherein the initial probing power can be determined by parameters acquired in the message transmitted by Node B in responding the P2P request of the UE, such as the estimated path-loss between the link probing originator and the link probing responder within the acceptable radio range for P2P communication, the receiver sensitivity and the power level of the link probing responder; a monitoring unit, for monitoring the direct communication link to detect an ACK message from the link probing responder; a communicating unit, for communicating directly with the link probing responder via the direct communication link after receiving the ACK message from the link probing responder; a power adjusting unit, for adjusting the probing power of the UE so that the UE can transmit connect probing signals with the adjusted probing power when failing to receive the ACK message from the link probing responder, wherein the power adjusting unit can adjust the UE's probing power many times so that the UE can retransmit connect probing signals with the adjusted probing power many times; a counter, for triggering request for switching to conventional communication mode when the number of re-transmitting connect probing signals exceeds the threshold value of the counter; a request switching means, for requesting to switch to conventional communication mode when said adjusted probing power exceeds the predefined maximum probing power or on receipt of the switch request triggered by the counter.

(2). When the UE allocated with direct communication link acts as the link probing responder, the system for P2P radio link establishment of the UE in wireless communication systems, includes: connect probing signal receiving means, for receiving connect probing signals from the link probing originator via the direct communication link; an ACK message sending means, for sending ACK messages to the link probing originator via the direct communication link on receipt of the connect probing signal and the connect probing signal meets the basic requirement for direct communication; a timer, for setting a time limit; a request switch unit, for requesting to switch to conventional communication mode when still failing to receive the connect probing signal meeting the basic requirement for direct communication from the link probing originator, as the time limit is exceeded.

(3). When the UE can act as both the link probing originator and the link probing responder, the system for P2P radio link establishment of the UE in wireless communication systems, should contain all the hardware components above when the UE acts respectively as the link probing originator and the link probing responder.

2. About the Base Station Subsystem

The system for P2P radio link establishment of the base station subsystem in wireless communication systems, comprises: a receiving unit, for receiving request signals from the link probing originator and response signals from the link probing responder; an initial probing power message sending unit, for sending the information about setting the initial probing power to the link probing originator via the downlink control channel after allocating direct communication link to the UEs, according to the request signal and the response signal, wherein the information about setting the initial probing power can be included in the message sent to the UE by the base station subsystem as responding to the P2P request, and the information can also include parameters such as the estimated path-loss between the link probing originator and the link probing responder within the acceptable radio range for P2P communication, the receiving sensitivity and the receiving power level of the link probing responder, and etc.

2. P2P Direct Communication Link Maintenance Procedure

During P2P communication procedure, the system for P2P radio link maintenance of the UE in wireless communication systems, comprises: a signal transmitting unit, for transmitting signals to another UE via the direct communication link; a signal receiving unit, for receiving signals transmitted from another UE via the direct communication link; a signal detecting unit, for detecting whether the signals from said another UE meet the QoS requirement for direct communication; a power control indication determining unit, for determining the power control indication according to a certain criterion, such as the SIR or BER requirement, when the QoS requirement for direct communication is met; a power control indication inserting unit, for inserting the power control indication into signals to be transmitted to said another UE; a power adjusting unit, for adjusting the transmission power of the UE according to the power control indication in signals sent from said another UE via the direct communication link; a timer, for setting a time limit; a request switching unit, for requesting to switch to conventional communication mode when the UE hasn't yet received signals transmitted via the direct communication link from said another UE as the time limit is exceeded.

3. Switching from P2P Direct Mode to Conventional Communication Mode

An system for the UEs in wireless communication systems to switch to conventional communication from P2P communication, comprises: a request sending unit, for sending request to the base station subsystem for switching to conventional communication mode via uplink control channel; a direct communication radio resource releasing request sending unit, for sending the ACK message of switching to conventional mode to the base station subsystem and sending request for releasing direct communication radio resource, on receipt of the ACK message of the request for switching sent by the base station subsystem via the downlink control channel and acquiring the reallocated traffic channel in conventional communication mode to enter into the dual-mode of direct communication and conventional communication; a mode switching unit, for switching to mere conventional communication mode from the dual-mode of direct communication and conventional communication on receipt of the ACK message of the request for releasing direct communication radio resource sent by the base station subsystem via the downlink control channel.

An system for switching to conventional communication mode from P2P communication for use in the base station subsystem in wireless communication systems, comprises: a conventional communication mode request receiving unit, for receiving the request for switching to conventional communication mode from the UEs via uplink control channel; a switch request ACK message sending unit, for sending the ACK message of switch request to the two UEs in direct communication mode and reallocating traffic channel in conventional communication mode so that the two UEs can enter into the dual-mode of direct communication and conventional communication; a direct communication radio resource releasing request receiving unit, for receiving the ACK message of switching to conventional mode and the request for releasing direct communication radio resource transmitted by the two UEs; a direct communication radio resource reclaiming unit, for reclaiming the direct communication radio resource; a direct communication radio resource release ACK message sending unit, for sending ACK messages of direct communication radio resource release to the two UEs via downlink control channel after reclaiming the direct communication radio resource, so that the two UEs can switch to mere conventional communication mode from the dual-mode of direct communication and conventional communication.

Wherein the base station subsystem may only allocate downlink traffic channel for the UEs, and uplink traffic channel may still be P2P-DCH, because Node B in the base station subsystem can also overhear the information exchanged by the UEs on P2P-DCH. Thus, P2P-DCh can be taken as the uplink traffic channel in conventional UP-UTRAN-DOWN communication mode, too.

As described above, in the method and system for radio link establishment with P2P communication in wireless communication systems as proposed in the present invention, the connect probing procedure is employed to send connect probing signals, which effectively ensures the P2P connection establishment between the UEs during P2P communication procedure. The UE keeps on monitoring the received signals from another UE during P2P communication procedure. In the case of meeting the basic QoS requirement, it generates power control commands to send to the peer UE by comparing the measurement value of the received signals with the target value with a certain criterion, and adjusts its own transmission power according to the power control commands sent by the peer UE contained in the received signals, which guarantees smooth operation of P2P communication. Further, the dual-mode transition phase of P2P direct communication and conventional communication is added here, so the UE can break down the direct communication only after the direct communication radio resource is reclaimed entirely, and thus the UE can switch smoothly to conventional communication mode from P2P communication mode.

It should be stressed herein that all the technical solutions in the present invention can be implemented by modifying high-layer protocol software modules in existing communication systems, so the hardware modules can be highly reused.

The power control scheme employed in the described method for maintaining radio link with P2P communication, primarily aims at voice service, but its working principle is also suitable for packet data services.

It is to be understood by those skilled in the art that the method for P2P radio link establishment and maintenance as proposed in this invention, is applicable to wireless Ad Hoc networks, 3GPP HCR-TDD systems, TD-SCDMA wireless communication systems, and other advanced wireless communication systems.

It is also to be understood by those skilled in the art that the method for P2P radio link establishment and maintenance disclosed in this invention can be modified considerably without departing from the spirit and scope of the invention as defined in the appended claims.

APPENDIX 1
Main parameters/part primitives to be modified in existing
technical specifications for P2P TDD CDMA (for reference)

| Message/parameters | 3GPP original | Modified/added information, | Source→ | Transport |
|---|---|---|---|---|
| for P2P | content | parameters or flag | destination | channel carrier |
| UE's P2P connect | UE's connect | Add P2P flag, destination | UE→ Node B | RACH |
| request/indication | request/indication | P2P-UE identification, etc. | | |
| P2P paging | Paging | Add P2P flag, and paging | Node B→ UE | PCH |
| | | message including the UE's | | |
| | | P2P connect request | | |
| | | information, etc. | | |
| Node B's P2P | Node B's connect | Add P2P flag, P2P channel | Node B→ UE | FACH |
| connect response/ | response/ACK | allocation, P2P-UE capability | | |
| ACK | | information (e.g., UE receiver | | |
| | | sensitivity and presetting | | |
| | | probing power level, etc.), | | |
| | | the estimated path-loss or | | |
| | | rough distance between two | | |
| | | P2P-UEs, etc. | | |
| UE's P2P connect | UE's connect | Add P2P flag, etc. | UE→ Node B | RACH |
| response/ACK | response/ACK | | | |
| UE's re-access | UE's connect | Add P2P flag, re-access Node | UE→ Node B | RACH |
| Node B request/ | request/indication | B flag, etc. | | |
| indication | | | | |
| Node B's UE re- | Node B's UE | Add P2P flag, channel re- | Node B→ UE | FACH |
| access response/ACK | connect | allocation. | | |
| | response/ACK | | | |
| UE's re-access | UE's connect | Add P2P flag, P2P resource | UE→ Node B | RACH |
| Node B response/ACK | response/ACK | release request, etc. | | |
| Node B's P2P | Node B's | Add P2P flag, channel re- | Node B→ UE | FACH |
| resource release | resource release | allocation, etc. | | |
| response/ACK | response/ACK | | | |
| UE's P2P connect | UE's connect | Add P2P flag, etc. | UE→ NodeB | RACH |
| release response/ACK | release | | | |
| | response/ACK | | | |
| P2P connect probing | Traffic data flow | Change into P2P connect | UE1→ UE2 | DCH |
| request/indication | | probing request/indication | | |
| | | primitive | | |
| P2P connect probing | Traffic data flow | Change into P2P connect | UE2→ UE1 | DCH |
| response/ACK | | probing response/ACK | | |
| | | primitive | | |
| P2P traffic data | Traffic data flow | Add P2P flag, etc. | UE1 [symbol] UE2 | DCH |
| flow | | | | |
| M | N/A | Connect probing re- | P2P-UE can update | FACH/PCH/BCH |
| | | transmission counter | this value from | |
| | | | Node B if needed | |
| TP2P_Probing | N/A | Connect probing timer | P2P-UE can update | FACH/PCH/BCH |
| | | | this value from | |
| | | | Node B if needed | |
| TP2P_connecting | N/A | Connect timer for maintenance | P2P-UE can update | FACH/PCH/BCH |
| | | procedure | this value from | |
| | | | Node B if needed | |
| | | Connect probing transmission | P2P-UE can update | FACH/PCH/BCH |
| | | power threshold and step size | these values from | |
| | | of probing power change | Node B if needed | |
| | | P2P-UE receive SIR threshold, | P2P-UE can update | FACH/PCH/BCH |
| | | power control target SIR for | these values from | |
| | | P2P connection | Node B if needed | |

1. A method for establishing P2P radio connection between two user equipments, wherein, after network system already allocates direct communication link to the user equipments, steps to be taken by the user equipment, as the link probing originator, comprising:
transmitting connecting probing signals with set initial probing power, to another user equipment as the link probing responder, via the allocated direct communication link;
monitoring the direct communication link to detect an acknowledge (ACK) message from said another user equipment as the link probing responder;
communicating directly via the direct communication link with said another user equipment as the link probing responder, after receiving the ACK message from the link probing responder;

2. The method for establishing P2P radio connection according to claim 1, steps to be taken by the user equipment, as the link probing responder, comprising:
receiving connecting probing signals from another user equipment as the link probing originator via direct communication link;
sending said ACK message to said another user equipment as the link probing originator via the direct communication link, when receiving the connecting probing signals and said signals meet the basic requirement for direct communication.

3. The method for establishing P2P radio connection according to claim 1, further comprising:
adjusting the probing power of the user equipment and retransmitting connecting probing signals with the adjusted probing power, when failing to receive said ACK message from said another user equipment as the link probing responder in a certain time.

4. The method for establishing P2P radio connection according to claim 3, wherein readjusting the probing power and retransmitting connecting probing signals with the readjusted probing power, when still failing to receive said ACK message from said another user equipment as the link probing responder in said certain time although the user equipment transmits signals with adjusted probing power.

5. The method for establishing P2P radio connection according to claim 3, further comprising:
setting an allowable maximum probing power;
sending a request to network system for switching to conventional communication mode, when said adjusted probing power exceeds said allowable maximum probing power.

6. The method for establishing P2P radio connection according to claim 4, further comprising:
setting the number of retransmitting connecting probing signals;
sending a request to network system for switching to conventional communication mode, when said number of retransmitting connecting probing signals is overrun.

7. The method for establishing P2P radio connection according to claim 1, wherein said initial probing power is set according to the information transmitted by network system via the downlink control channel.

8. The method for establishing P2P radio connection according to claim 7, wherein said information transmitted by the network system via the downlink control channel includes the estimated path loss level within the allowable radio scope of P2P communication between the link probing originator and the link probing responder.

9. The method for establishing P2P radio connection according to claim 7, wherein said information transmitted by the network system via the downlink control channel includes the receiving sensitivity of the link probing responder.

10. The method for establishing P2P radio connection according to claim 7, wherein said information transmitted by the network system via the downlink control channel includes the receiving power order of the link probing responder.

11. The method for establishing P2P radio connection according to claim 2, further comprising:
setting a time limit;
sending a request to the network system for switching to conventional communication mode, when still failing to receive link probing signals which meeting the basic requirement for direct communication from said another user equipment as the link probing originator, as the time limit is overrun.

12. A method for establishing P2P radio connection between two user equipments, wherein after the network system already allocates direct communication link to the user equipments, steps to be taken by the user equipment, as the link probe responder, comprising:
receiving connecting probing signals from another user equipment as the link probe originator via the direct communication link;
sending an acknowledge (ACK) message to said link probing originator via the direct communication link when receiving connecting probing signals and the connecting probing signals meet the basic requirement for direct communication.

13. The method for establishing P2P radio connection according to claim 12, further comprising:
setting a time limit;
sending a request to the network system for switching to conventional communication mode, when failing to receive the connecting probing signals which meeting the basic requirement for direct communication from said link probing originator as the time limit is overrun.

14. A user equipment, comprising:
a connecting probing signal transmitting unit, for transmitting connecting probing signals with set initial probing power to another user equipment as the link probing responder via the direct communication link allocated by the network system;
a monitoring unit, for monitoring the direct communication link to detect a acknowledge (ACK) message from the link probing responder;
a communicating unit, for communicating directly with the link probing responder via the direct communication link after receiving said ACK message from the link probing responder.

15. The user equipment according to claim 14, further comprising:
a connecting probing signal receiving means, for receiving connecting probing signals from said another user equipment as the link probing originator via the direct communication link;
an ACK message sending means, for sending an ACK message to the link probing originator via the direct communication link when receiving connecting probing signals and the connecting probing signals meet the basic requirement for direct communication.

16. The user equipment according to claim 14, further comprising:
a power adjusting unit, for adjusting the probing power of the user equipment so that the user equipment can transmit connecting probing signals with the adjusted probing power when failing to receive the ACK message from said another user equipment as the link probing responder in a certain time.

17. The user equipment according to claim 16, further comprising:
request switching unit, for requesting the network system for switching to conventional communication mode when said adjusted probing power is overrunning the predefined maximum probing power.

18. The user equipment according to claim 16, further comprising:
a counter, for counting the number of retransmitting connecting probing signals with the probing power adjusted by the user equipment;
a requesting switch means, for sending request to the network system for switching to conventional communication mode when the number of retransmitting connecting probing signals exceeds the threshold of the counter.

19. The user equipment according to any claim from 14, wherein said initial probing power is set according to the information transmitted by the network system via the downlink control channel.

20. The user equipment according to claim 19, wherein said information transmitted by the network system via the downlink control channel includes the estimated path loss level within allowable radio scope of P2P communication between the link probing originator and the link probing responder.

21. The user equipment according to claim 19, wherein said information transmitted by the network system via the downlink control channel includes the receiving sensitivity of the link probing responder.

22. The user equipment according to claim 19, wherein said information transmitted by the network system via the downlink control channel includes the receiving power level of the link probing responder.

23. The user equipment according to claim 15, further comprising:
a timer, for setting a time limit;
a requesting switch unit, for sending a request to the network system for switching to conventional communication mode when still failing to receive the connecting probing signals meeting the basic requirement for direct communication from said another user equipment as the link probing originator, as the time limit is overrun.

24. A user equipment, comprising:
a connecting probing signal receiving means, for receiving connecting probing signals from the link probing originator via the direct communication link, wherein the direct communication link is allocated to the user equipment by the network system;
an ACK message sending means, for sending ACK messages to the link probing originator via the direct communication link when receiving connecting probing signals and the connecting probing signals meet the basic requirement for direct communication.

25. The user equipment according to claim 24, further comprising:
a timer, for setting a time limit;
a requesting switch unit, for sending a request to the network system for switching to conventional communication mode, when still failing to receive the connecting probing signals meeting the basic requirement for direct communication from said another user equipment as the link probing originator, as the time limit is overrun.

26. A method for wireless communication systems to establish P2P radio connection, comprising:
receiving a requesting signal from the link probing originator and a response signal from the link probing responder;
transmitting the information about setting the initial probing power to the link probing originator via the downlink control channel, after allocating direct communication link to the user equipments (link probing originator and responder), according to the request signal and the response signal.

27. The method for establishing P2P radio connection according to claim 26, wherein said information about setting the initial probing power transmitted by the network system includes the estimated path loss level within the allowable radio scope of P2P communication between the link probing originator and the link probing responder.

28. The method for establishing P2P radio connection according to claim 26, wherein said information about setting the initial probing power transmitted by the network system includes the receiving sensitivity of the link probing responder.

29. The method for establishing P2P radio connection according to claim 26, wherein said information about setting the initial probing power transmitted by the network system includes the receiving power level of the link probing responder.

30. A network system, comprising:
a receiving unit, for receiving request signals from the link probing originator and response signals from the link probing responder;
a transmitting unit, for transmitting the information about setting the initial probing power to the link probing originator via the downlink control channel after allocating direct communication link to the user equipments (link probing originator and responder), according to the request signals and the response signals.

31. The network system according to claim 30, wherein said information about setting the initial probing power includes the estimated path loss level within the allowable radio scope of P2P communication between the link probing originator and the link probing responder.

32. The network system according to claim 30, wherein said information about setting the initial probing power includes the receiving sensitivity of the link probing responder.

33. The network system according to claim 30, wherein said information about setting the initial probing power includes the receiving power rate of the link probing responder.

34. A method for maintaining P2P radio connection between two user equipments, wherein after the network system already allocates direct communication link to the user equipments, steps to be taken by the user equipment, comprises:
transmitting signals to another user equipment via the direct communication link;
receiving signals transmitted from said another user equipment via the direct communication link;
detecting whether signals from said another user equipment meet the basic Qos requirement for direction communication;
determining power control command indication according to a certain rule when the basic Qos requirement for direction communication is met;
inserting the power control command indication into signals to be transmitted to said another user equipment;
adjusting the transmission power of the user equipment, according to the power control command indication in the signals sent via the direct communication link from said another user equipment.

35. The method for maintaining P2P radio connection according to claim 34, further comprising:
setting a time limit;
sending a request to the network system for switching to conventional communication mode, when still failing to receive signals from said another user equipment via the direct communication link, as the time limit is overrun.

36. The method for maintaining P2P radio connection according to claim 34, further comprising:
the user equipment requests the network system for switching to conventional communication mode when the communication performance can't meet the basic QoS requirement.

37. The method for maintaining P2P radio connection according to claim 34, wherein when said certain rule is the requirement for SIR, said steps to determine power control command indication according to the certain rule, further comprising:
comparing the SIR of received signals transmitted from said another user equipment via the direct communication link, with the target SIR, to determine power control command indication.

38. The method for maintaining P2P radio connection according to claim 34, wherein when said certain rule is the requirement for BER, said steps to determine power control command indication according to the certain rule, further comprising:
comparing the BER of received signals transmitted from another user equipment via the direct communication link, with the predefined BER, to determine power control command indication.

39. A user equipment, comprising:
a signal transmitting unit, for transmitting signals to another user equipment via the direct communication link, wherein the direct communication link is allocated to the user equipment by the network system;
a signal receiving unit, for receiving signals transmitted from said another user equipment via the direct communication link;
a signal detecting unit, for detecting whether the signals from said another user equipment meet the QoS requirement for direct communication;
a power control command indication determining unit, for determining power control command indication according to a certain rule when the QoS requirement for direct communication is met;
a power control command indication inserting unit, for inserting the power control command indication into signals to be transmitted to said another user equipment;
a power adjusting unit, for adjusting the transmission power of the user equipment according to the power control command indication in signals sent from said another user equipment via the direct communication link.

40. The user equipment according to claim 39, further comprising:
a timer, for setting a time limit;
a request switching unit, for requesting the network system for switching to conventional communication mode when the user equipment still hasn't received signals transmitted via the direct communication link from said another user equipment as the time limit is overrun.

41. The user equipment according to claim 39, further comprising:
a switching unit, for requesting the network system for switching to conventional communication mode when direct communication can't meet the QoS requirement.

42. The user equipment according to claim 39, further comprising:
a comparing unit, for comparing the SIR of received signals transmitted from said another user equipment via the direct communication link, with the target SIR, or comparing the BER of received signals transmitted from another user equipment via the direct communication link, with the predefined BER, to determine the power control command indication.

43. A method for a user equipment to switch to conventional communication from P2P communication, comprising:
the user equipment in direct communication mode sends request to the network system for switching to conventional communication mode via uplink control channel;
entering into the dual-mode state of direct communication and conventional communication after receiving the ACK message of the request for switching sent by the network system via the downlink control channel and acquiring the reallocated traffic channel in conventional communication mode;
sending request to the network system for releasing the direct communication radio resource after entering into the dual-mode state;
switching to single conventional mode from the dual-mode state of direct communication and conventional communication after receiving the ACK message of the request for releasing the direct communication radio resource sent by the network system via the downlink control channel.

44. The method for switching to conventional communication from P2P communication according to claim 43, wherein said traffic channel in conventional communication mode reallocated to the user equipment includes downlink/uplink traffic channel.

45. The method for switching to conventional communication from P2P communication according to claim 43, wherein said traffic channel in direct communication link can be taken as uplink traffic channel or downlink traffic channel in conventional communication mode.

46. A method for wireless communication network system to switch to conventional communication from P2P communication, comprising:
receiving requests for switching to conventional communication mode sent from user equipments in direct communication mode via the uplink control channel;
sending the ACK messages of the requests for switching via the downlink control channel, to the two user equipments in direct communication mode and reallocating traffic channel in convention communication mode to them so that the two user equipments can enter into the dual-mode state of direct communication and conventional communication;
receiving requests for releasing direct communication radio resource sent from the two user equipments;
withdrawing the direct communication radio resource;
sending the ACK messages of the requests for releasing direct communication radio resource via the downlink control channel to the two user equipments, so that the two user equipments can switch to single conventional communication mode from the dual-mode state of direct communication and conventional communication;

47. The method for switching to conventional communication from P2P communication according to claim 46, wherein said traffic channel in conventional communication mode reallocated to the two user equipments by the network system includes downlink traffic channel and/or uplink traffic channel.

48. The method for switching to conventional communication from P2P communication according to claim 46, wherein the traffic channel in direct communication can be taken as the uplink traffic channel or downlink traffic channel in conventional communication.

49. A user equipment, comprising:
a sending unit, for sending request to the network system via the uplink control channel for switching to conventional communication mode and sending request to the network system for releasing direct communication radio resource after receiving the ACK message of the request for switching sent by the network system via the downlink control channel and acquiring reallocated traffic channel in conventional communication mode to enter into the dual-mode of direct communication and conventional communication;
a mode switching unit, for switching to single conventional communication mode from the dual-mode of direct communication and conventional communication after receiving the ACK message of the request for releasing direct communication radio resource sent by the network system via the downlink control channel.

50. The user equipment according to claim 49, wherein said traffic channel in conventional communication mode reallocated to the user equipment includes downlink traffic channel and/or uplink traffic channel.

51. The user equipment according to claim 49, wherein said traffic channel of direct communication link can be taken as uplink traffic channel or downlink traffic channel in conventional communication mode.

52. A network system, comprising:
a receiving unit, for receiving requests for switching to conventional communication mode sent by user equipments in direct communication mode via uplink control channel, and receiving requests for releasing direct communication radio resource sent by the two user equipments;
a sending unit, for sending the ACK messages of requests for switching via the downlink control channel to the two user equipments in direct communication mode to reallocate traffic channel in conventional communication mode for them, and sending the ACK messages of requests for releasing direct communication radio resource via the downlink control channel to the two user equipments after withdrawing radio resource;
a direct communication radio resource withdrawing unit, for withdrawing direct communication radio resource.

53. The network system according to claim 52, wherein said traffic channel in conventional communication mode reallocated to the two user equipments by the network system includes downlink traffic channel and/or uplink traffic channel.

54. The network system according to claim 52, wherein said traffic channel of direct communication link can be taken as uplink traffic channel or downlink traffic channel in conventional communication mode.
